(19) United States
(12) Patent Application Publication
(10) Pub. No.: US 2012/0134161 A1
(43) Pub. Date: May 31, 2012

(54) LIGHTING APPARATUS

(76) Inventors: Nobuo Kawamura, Kumagaya-shi (JP); Masahiro Yokota, Fukaya-shi (JP); Osamu Ono, Fukaya-shi (JP); Ken Takahashi, Kumagaya-shi (JP); Takeshi Ookawa, Kumagaya-shi (JP); Shusuke Morita, Fukaya-shi (JP); Takashi Nishimura, Fukaya-shi (JP); Hidemi Matsuda, Toda-shi (JP)

(21) Appl. No.: 13/231,245

(22) Filed: Sep. 13, 2011

Related U.S. Application Data
(63) Continuation of application No. PCT/JP2011/068175, filed on Aug. 9, 2011.

(30) Foreign Application Priority Data
Nov. 30, 2010 (JP) 2010-267581
Feb. 28, 2011 (JP) 2011-042697

(51) Int. Cl. F21V 3/00

(52) U.S. Cl. 362/363

(57) ABSTRACT

According to one embodiment, an lighting apparatus includes a base member, a light source configured to emit visible light, and a translucent cover including a translucent region which covers at least a front surface of the light source and emits the light emitted from the light source to the outside. The light source is provided on a front surface flat section of the base member, a luminous intensity of the light emitted from the light source has a directionality which is strong in a normal direction of the front surface flat section and becomes zero on a rear surface side. The translucent cover includes a domed shape having a maximum diameter at a position higher than a height of the position where the light source is arranged, and a transmittance of a region opposing the light source is 60% or less.

### CROSS-REFERENCE TO RELATED APPLICATIONS

This application is a Continuation Application of PCT Application No. PCT/JP2011/068175, filed Aug. 9, 2011 and based upon and claiming the benefit of priority from prior Japanese Patent Applications No. 2010-267581, filed Nov. 30, 2010; and No. 2011-042697, filed Feb. 28, 2011, the entire contents of all of which are incorporated herein by reference.

### FIELD

Embodiments described herein relate generally to a lighting apparatus using a light source which is surface mounted and has a narrowly oriented light distribution as a white LED.

### BACKGROUND

As a lighting apparatus, although an incandescent lamp making use of emission by the heat of a filament and a fluorescent lamp using emission generated by exciting a fluorescence substance by ultraviolet rays have been widely used, these apparatuses have problems of short useful life, emission of infrared rays (emission of ultraviolet rays), use of mercury, emission efficiency, and the like.

In recent years, as a technology for solving these problems, an LED light source and an electroluminescent light source are developed and more particularly the LED light source is acceleratingly used to an ordinary lighting apparatus.

However, an ordinary surface-mounting-type LED light source has such a directionality that light is emitted strongly in the normal direction of a mounting substrate, and when an angle to the normal direction of the mounting substrate is shown by A, luminous intensity is attenuated in proportion to cos G. This is because the structure of the ordinary LED light source is configured such that an LED chip for emitting primary light rays is covered with a protection layer containing a fluorescence substance for converting the primary light rays to secondary light rays in a planar state. Thus, a lighting apparatus using the LED light source to an electric bulb and a fluorescent lamp has a luminous intensity distribution in which light is strong in the normal direction of a mounting substrate and light is not almost emitted from the side of the mounting substrate to a rear surface direction. Therefore, when a conventional incandescent lamp or a fluorescent lamp which has an approximately uniform luminous intensity distribution from a front surface to a rear surface is replaced with a lighting apparatus using the LED light source, the brightness of a ceiling and a wall is significantly changed and the ceiling and the wall become different illumination spaces.

As a technology for emitting light also in a rear surface direction by a lighting apparatus using the LED light source, there is a technology for configuring a flat surface on which LEDs are mounted as a polyhedron and disposing the LEDs so as to face in side surface and rear surface directions. Further, as another technology, there is a lighting apparatus in which the inner surface of a translucent cover is coated with a fluorescence substance which is excited by the light of an LED light source so that the translucent cover itself emits light.

When an LED light source is mounted so as to face a side surface or a rear surface, it becomes complicated to manufacture and assemble a lighting apparatus as well as a problem arises in a difficulty of design of mechanical strength and heat radiation property. Further, when a translucent cover is coated with a fluorescence substance, it also becomes complicated to manufacture and assemble a lighting apparatus likewise.

### BRIEF DESCRIPTION OF THE DRAWINGS

FIG. 1 is a cross-sectional view showing an electric-bulb-type lighting apparatus according to a first embodiment;

FIG. 2 is a cross-sectional view showing a fluorescent-lamp-type lighting apparatus according to the first embodiment;

FIG. 3 is a view showing the relationship between luminous intensity and angle to the normal direction of an LED light source;

FIG. 4 is a view showing the relationship among the transmittance of a translucent cover of the lighting apparatus, a half-value light orientation angle 2θ·½, and an efficiency;

FIG. 5 is a cross-sectional view of the electric-bulb-type lighting apparatus schematically showing how light rays travel in the lighting apparatus;

FIGS. 6A, 6B, 6C and 6D are views of the electric-bulb-type lighting apparatus in which area ratios are compared with each other when the dome of the translucent cover is variously changed;

FIG. 7 is a view showing the relationship among the transmittance of a translucent cover, a half-value light orientation angle 2θ·½, and an efficiency as to respective lighting apparatuses when the dome of the translucent cover is variously changed;

FIG. 8 is a view showing the relationship between an efficiency and a transmittance of the translucent cover as to respective lighting apparatuses when the dome of the translucent cover is variously changed;

FIG. 9 is a view showing the relationship between an area ratio and a half value light orientation angle 2θ·½ as to respective lighting apparatuses when the dome of the translucent cover is variously changed;

FIG. 10 is a view showing the relationship between an area ratio and an efficiency as to respective lighting apparatuses when the dome of the translucent cover is variously changed;

FIG. 11 is a view showing the relationship between an area ratio and a half-value light orientation as to the translucent cover having various different transmittance;

FIG. 12 is a cross-sectional view showing an electric-bulb-type lighting apparatus according to a second embodiment;

FIG. 13 is a cross-sectional view showing a fluorescent-lamp-type lighting apparatus according to the second embodiment;

FIG. 14 is a cross-sectional view showing an electric-bulb-type lighting apparatus according to a third embodiment;

FIG. 15 is a cross-sectional view showing a fluorescent-lamp-type lighting apparatus according to the third embodiment;

FIG. 16 is a cross-sectional view showing a modified example of an electric-bulb-type lighting apparatus according to a third embodiment;

FIG. 17 is a view showing the relationship between luminous intensity and angle to the normal direction of an LED light source in the lighting apparatus according to the third embodiment;

FIG. 18 is a cross-sectional view showing an electric-bulb-type lighting apparatus according to a fourth embodiment;

FIG. 19 is a radar chart showing the luminous intensity distribution when the transmittance of a dull resin configuring a translucent cover is changed in a lighting apparatus according to a fourth embodiment;

FIG. 20 is a cross-sectional view showing a lighting apparatus according to a fifth embodiment;

FIG. 21 is a cross-sectional view showing an electric-bulb-type lighting apparatus according to a sixth embodiment;

FIG. 22 is a plan view showing a base and a light source of the electric-bulb-type lighting apparatus according to the sixth embodiment;

FIG. 23 is a view showing the relationship among the angle to the tangent line of a translucent cover, a half-value light orientation angle 2θ·½, and an efficiency in the electric-bulb-type lighting apparatus according to the sixth embodiment when the offset amount of a light source is changed;

FIG. 24 is a view showing the relationship in the electric-bulb-type lighting apparatus according to the sixth embodiment, translucent cover transmittance, half-value light orientation angle 2θ·½ and efficiency;

FIG. 25 is a cross-sectional view showing a fluorescent-lamp-type lighting apparatus according to the sixth embodiment;

FIG. 26 is a plan view showing a base of the fluorescent-lamp-type lighting apparatus and the light source according to the sixth embodiment; and

FIG. 27 is a view showing the relationship among the angle to the tangent line of a translucent cover, a half-value light orientation angle 2θ·½, and an efficiency in the fluorescent-lamp-type lighting apparatus according to the sixth embodiment when the offset amount of a light source is changed.

### DETAILED DESCRIPTION

Various embodiments will be described in detail with reference to drawings. In general, according to one embodiment, an lighting apparatus comprises: a base member; a light source configured to emit visible light; and a translucent cover comprising a translucent region which covers at least a front surface of the light source and emits the light emitted from the light source to the outside. The light source is provided on a front surface flat section of the base member, a luminous intensity of the light emitted from the light source has a directionality which is strong in a normal direction of the front surface flat section and becomes zero on a rear surface side, and the translucent cover comprises a domed shape having a maximum diameter at a position higher than a height of the position where the light source is arranged, and a transmittance of a region opposing the light source is 60% or less.

### First Embodiment

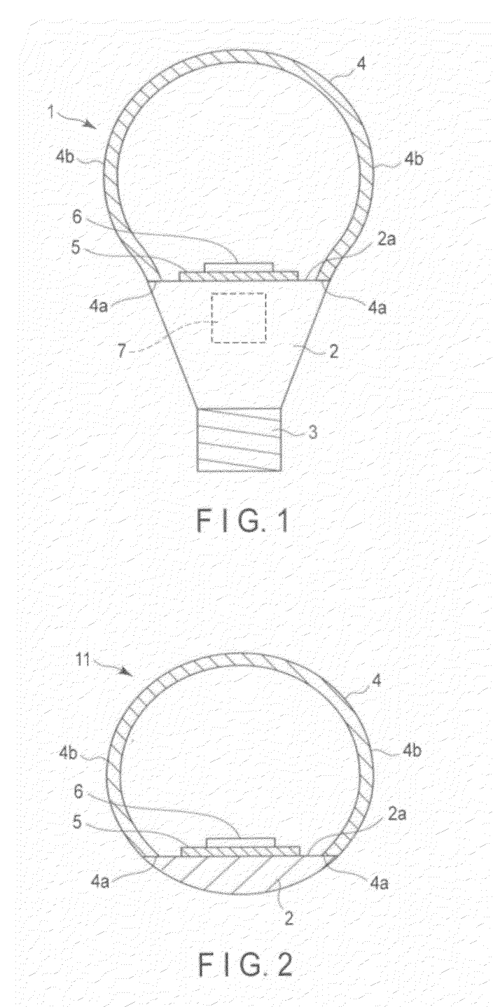

FIG. 1 shows an LED bulb 1 as an electric-bulb-type lighting apparatus according to a first embodiment, and FIG. 2 shows a cross-section of an LED fluorescent lamp 11 as a fluorescent-lamp-type lighting apparatus according to the first embodiment. The LED bulb 1 has a rotation-symmetrical shape to a center axis, and the LED fluorescent lamp 11 has a rod-shaped three dimensional shape extending linearly or an annular shape extending in a curved shape.

The LED bulb 1 and the LED fluorescent lamp 11 include a base member 2 having a front flat section 2a, a light source 6 composed of an LED mounted on a substrate 5, and a translucent cover 4. The substrate 5 and the translucent cover 4 on which the light source 6 is mounted is supported by the front flat section 2a of the base member 2. The LED as the light source 6 has directionality such that the luminous intensity of the light emitted from the LED is strong in the normal direction of the front flat section 2a and becomes zero on a rear surface side.

The translucent cover 4 of the LED bulb 1 is formed in a shape obtained by, for example, partly cutting off a member having an approximately circular cross-section, and an opening end 4a of the translucent cover 4 is securely fastened to the front flat section 2a. Further, the translucent cover 4 of the LED fluorescent lamp 11 has a cross-section having, for example, an elongate cylindrical shape obtained by partly cutting off a sphere, and the opening end 4a is securely fastened to the front flat section 2a. With the configuration, the translucent cover 4 covers the front surface and the side surface of the light source 6.

The translucent cover 4 has a shape in which the intermediate section of the cross-section of the translucent cover 4 domes outward. The translucent cover 4 is formed in such a shape that it has a maximum diameter section 4b or a maximum width section 4b which has a diameter or a width larger than the diameter or the width of the opening end 4a securely fastened to the front flat section 2a of the base member 2. That is, the translucent cover 4 is formed in a domed shape having the maximum diameter section 4b at a position higher than the position where the light source 6 is disposed.

The translucent cover 4 of the LED bulb 1 is formed of a material in which a scattering material for scattering light is mixed with a polycarbonate resin by injection molding. The translucent cover 4 has a spherical domed shape having a thickness of 1 mm with the maximum diameter section 4b set to, for example, 60 mm, the diameter of the rear surface side end (opening end) 4a set to 42 mm, and the height from the maximum diameter section 4b to the rear surface side end 4a set to about 27 mm. Further, the thickness of the translucent cover 4 and the density of the scattering material are designed so that the transmittance of the translucent cover 4 becomes about 50%.

The translucent cover 4 of the LED fluorescent lamp 11 is formed of a material in which a scattering material for scattering light is mixed with a polycarbonate resin by extrusion molding. The translucent cover 4 has a cylindrical domed shape having a thickness of 1 mm with the maximum diameter section 4b set to, for example, 22 mm, and the diameter of the rear surface side end (opening end) 4a set to about 14.6 mm. Further, the thickness of the translucent cover 4 and the density of the scattering material are designed so that the transmittance of the translucent cover 4 becomes about 50%.

Note that the diameter or the width of the front flat section 2a of the base member 2 is formed approximately the same as the diameter or the width of the opening end 4a of the translucent cover 4.

The translucent cover 4 has a translucent region which covers at least the front surface of the light source 6 and emits the light emitted from the light source to the outside. In the embodiment, the entire region of the translucent cover 4 forms the translucent region through which light passes. Note that, in the embodiment, an upper direction (normal direction) vertical to the front flat section 2a is called a front surface direction, a direction parallel with the front flat section 2a is called a side surface direction, and a lower direction vertical to the front flat section 2a is called a rear surface direction.

In the LED bulb 1, a bayonet cap 3 as a terminal on a power supply side is attached the rear surface side end of the base member 2. A driver circuit 7 for driving the light source 6 is disposed inside the base member 2. Power is supplied from the bayonet cap 3 to the driver circuit 7, and the light source 6 is lit by the driver circuit 7. The base member 2 has also a role for releasing the heat generated in the light source 6 and is composed of, for example, a metal material having a large heat capacity.

In the LED fluorescent lamp 11, a driver circuit is disposed independently of the lighting apparatus. Accordingly, the base member 2 may be configured as an integrated member acting also as the substrate 5 composed of aluminum. The LED fluorescent lamp 11 has a shape formed by extending a cross-section shown in FIG. 2 about 1.2 m. The light source 6 is configured by linearly disposing a plurality of surface-mounting-type LEDs on the front flat section 2a of the base member 2.

Although the transmittance of a translucent cover is conventionally set to 80 to 90% or is made transparent, according to the first embodiment, the transmittance of the translucent cover 4 is set to a low value of about 50%.

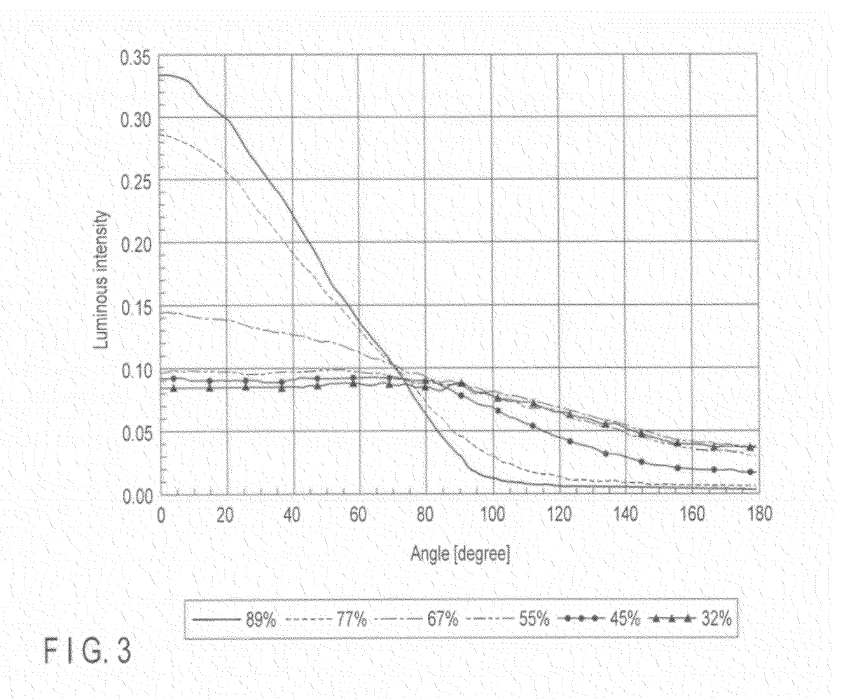

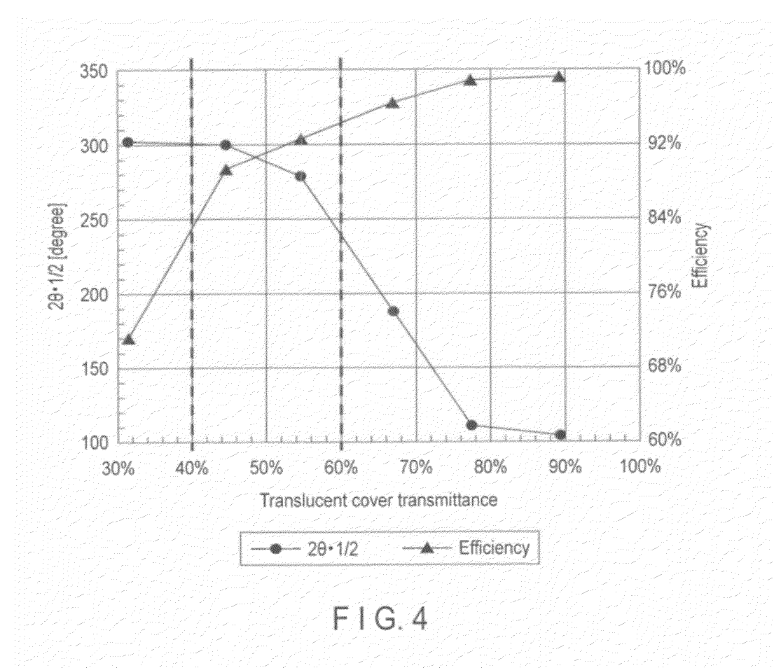

FIG. 3 is a graph showing the distribution of oriented light when the transmittance of the translucent cover 4 is changed from 89 to 32% in the LED bulb 1, wherein the vertical axis represents luminous intensity and the horizontal axis represents azimuth angle at which the normal direction of the front flat section 2a is set to 0°. FIG. 4 shows the relationship between half-value light orientation angle (2θ·½) and efficiency when the transmittance of the translucent cover 4 shown in FIG. 3 is varied, wherein the vertical axis represents angle range (half-value light orientation angle) at which the luminous intensity is reduced to half on the left and the illumination efficiency of the LED bulb 1 on the right, respectively, and the horizontal axis represents the transmittance of a sheet piece having the same material and the same thickness as those of the translucent cover 4, the transmittance being measured based on the measurement of entire light rays described in JIS-K-7361.

It can be found from FIGS. 3 and 4 that when the transmittance of the translucent cover 4 is lowered, the light orientation angle is expanded although the efficiency is degraded. This is because that when the light source 6 having a strong directionality is used, the translucent cover 4 itself behaves as if it is a light source by restricting the light directly passing through the translucent cover 4 and outputting the light after it is reflected and diffused inside the translucent cover 4. Specifically, when the transmittance of the translucent cover 4 is 60% or more, the light having the strong directionality passes through the translucent cover 4, whereas when the transmittance of the translucent cover 4 is 40% or less, the expansion of the light orientation angles is saturated and the efficiency is simply degraded. Accordingly, it is desirable that the transmittance of the translucent cover 4 is set to 40 to 60%. As a result, the LED bulb 1 having the translucent cover 4 with the domed shape shown in FIG. 1 can expand the range, in which the luminous intensity is reduced to half, from the conventional 120° to 290°. Likewise, the LED fluorescent lamp 11 having the domed translucent cover 4 shown in FIG. 2 can increase the range, in which the luminous intensity is reduced to half, from the conventional 120° to 220°. That is, according to the LED bulb 1 and the LED fluorescent lamp 11, the angle range in which the luminous intensity is high can be increased and strong light can be radiated also to the side surface side of the front flat section 2a.

Further, when the transmittance of the translucent cover 4 becomes 60% or less as described above, since the translucent cover 4 itself is brightened by approximately the same luminance in its entire region by the reflection scattering light inside the translucent cover 4, the translucent cover 4 which is configured spherical and has a uniform thickness as the first embodiment can achieve an oriented light distribution and a luminance distribution in an extremely large degree of unevenness. In particular, when compared with an LED bulb using a conventional translucent cover having a high transmittance, the entire region of the translucent cover 4 can be brightened by the same low luminance eliminating an extremely high luminance section on the translucent cover 4 corresponding to the LED light source. Accordingly, glaring can be drastically reduced. Consequently, a lighting apparatus near to a conventional incandescent lamp and fluorescent lamp can be achieved using the translucent cover 4 having the domed shape, the uniform thickness, and the low transmittance as shown in the first embodiment.

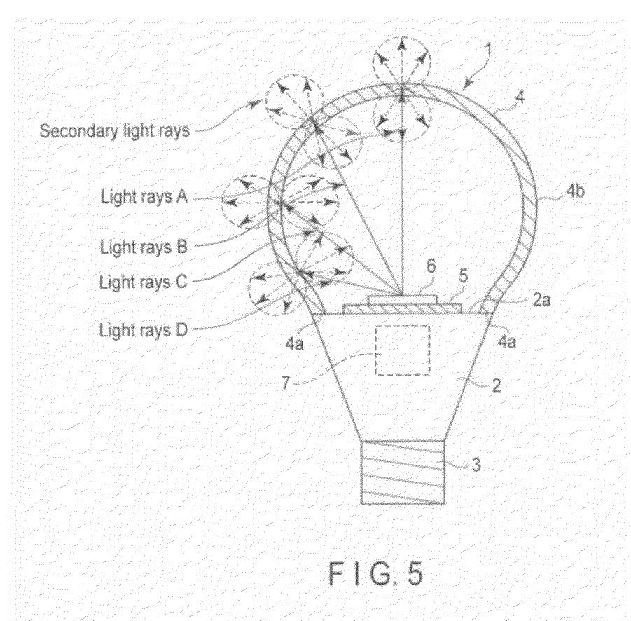

A detailed operation of the first embodiment will be described using FIGS. 5, 6A, 6B, 6C, 6D, 7, 8, 9, 10, and 11.

FIG. 5 is a view showing how light rays of the LED bulb 1 shown in FIG. 1 travel. Light rays A, B, C, D in the drawing show light ray which are emitted from the light source 6 and are travelling toward the translucent cover 4, and broken arrows and broken circles show secondary light rays reflected and scattered by the translucent cover 4. As described above, in the first embodiment, since the secondary light rays are sufficiently diffused by the diffusion material inside the translucent cover 4, when the angle from the normal direction of the surface of the translucent cover 4 is shown by θ, light is emitted in the distribution of oriented lights according to cos θ. The circles in the drawing schematically show the light intensity of the diffused light rays according to the cosine distribution, and the longest broken arrows are directed in the normal direction of the surface of the translucent cover 4.

As shown in FIG. 5, it can be found that the first embodiment is configured such that all the regions of the translucent cover 4 receive the light from the light source 6. Further, it can be found that all the light rays, which are reflection scattered from the translucent cover 4 and emitted to the outside, have a cosine distribution in which they are mainly directed in the normal direction of the translucent cover 4 and that the spherical domed shape widely achieves a natural oriented light distribution. In particular, as shown by the trajectory of the light ray D, it can be found that the spherical region on the rear surface side (the light source side) of the domed translucent cover 4 strongly contributes to the radiation in the rear surface direction and that light can be more strongly radiated in the rear surface direction by increasing the region.

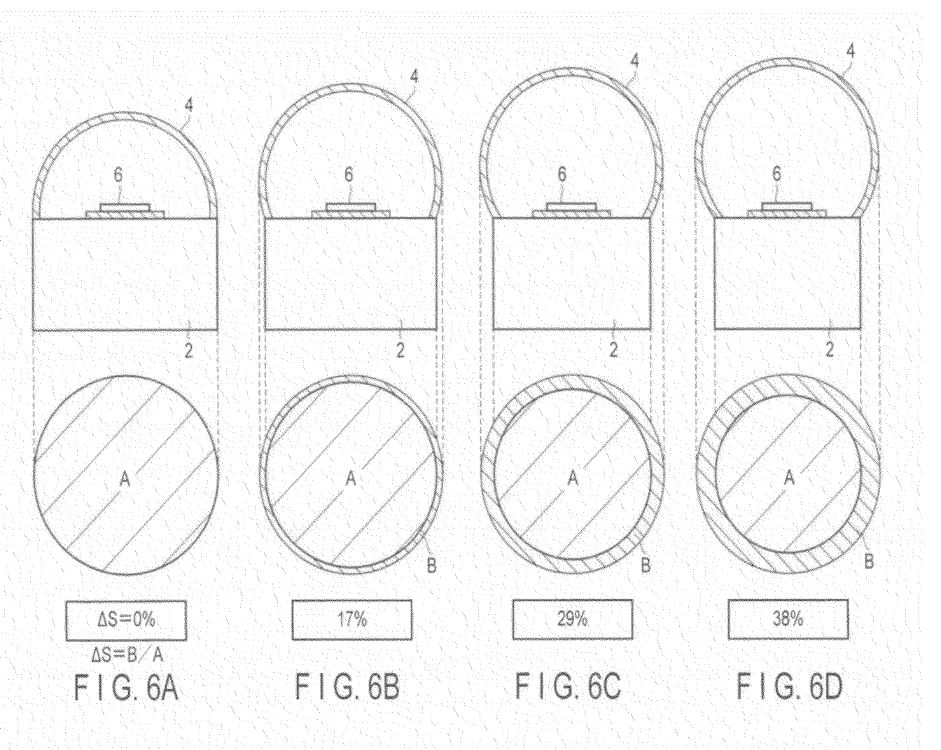

FIGS. 6A, 6B, 6C, 6D, 7, 8, 9, and 10 show a result when the effect is verified. FIGS. 6A, 6B, 6C, and 6D show the LED bulbs 1 using the translucent cover 4 in which the maximum diameter section 4b is set to 60 mm and the domes are variously changed. To show the dome by a numerical value, when the largest area of the LED bulb viewed from the rear surface direction is shown by A and the translucent region area of the LED bulb viewed from the rear surface direction is shown by B, B/A is shown by LS (percent). In the verified LED bulbs, although ΔS is set to 0, 17, 29, 38%, in the LED bulb 1 of the first embodiment, ΔS is 51%.

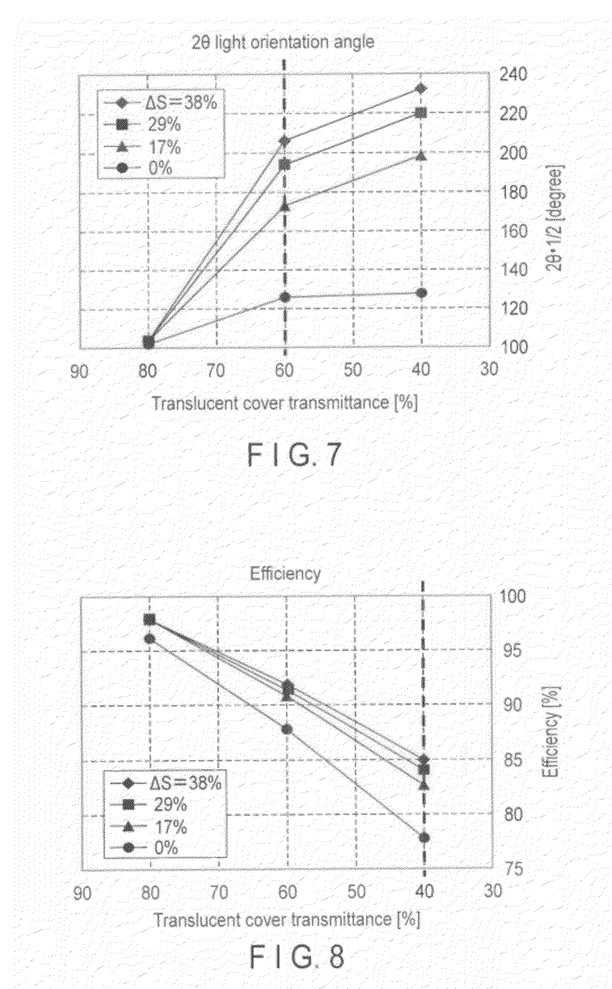

FIGS. 7 and 8 show the influence of the half-value light orientation angle and the efficiency of the LED bulbs shown in FIGS. 6A, 6B, 6C, and 6D when a horizontal axis shows a transmittance, respectively. It is as described in FIG. 4 that when the transmittance is 60% or less, the oriented light distribution is expanded and that when the transmittance is 40% or more, an efficiency degradation does not become significant. When attention is paid to ΔS, it can be found that when ΔS is 0% (i.e., the translucent cover 4 is hemispherical), the expansion of the oriented light distribution and the effect of suppressing an efficiency loss are extremely small, and as ΔS becomes larger, the effect becomes significantly.

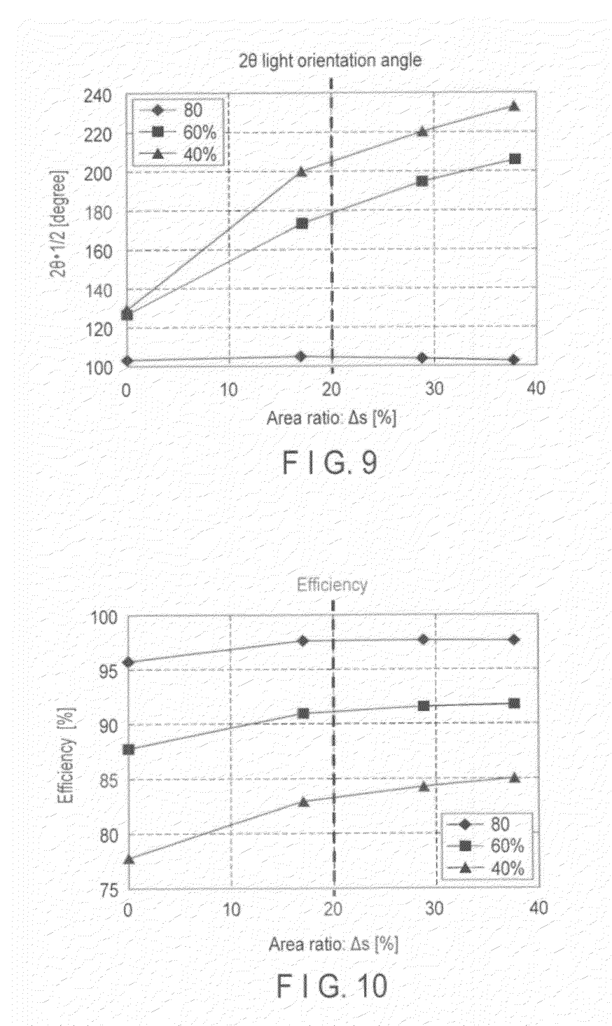

FIGS. 9 and 10 show graphs in which the x-axes of FIGS. 7 and 8 are changed to ΔS. It can be found from the views that, in the range of the transmittance of from 40 to 60%, when ΔS is increased, the oriented light distribution is expanded as well as the efficiency loss is reduced. When it is intended to sufficiently radiate light up to the rear surface side of the light source 6, the half-value light orientation angle is preferably 180° or more, and, in the case, it is sufficient to set ΔS to 20% or more. The transmittance of the translucent cover 4 is preferably 40 to 60%, and, in a high transmittance of 60% or more, the light rays from the light source 6 pass through the translucent cover 4, oriented light is not expanded, and, in a low transmittance of 40% or less, light rays pass through the translucent cover 4 less easily and the efficiency is greatly degraded.

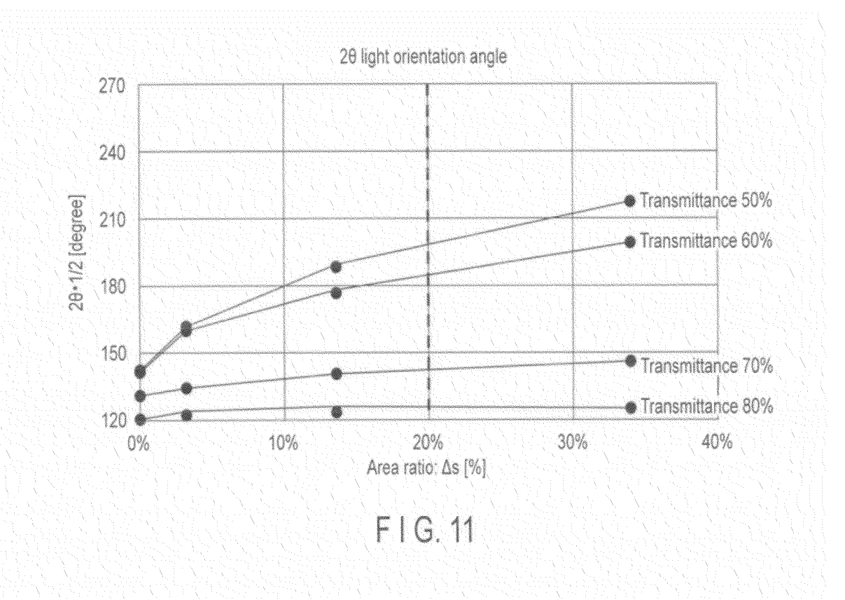

FIG. 11 shows a result when the same verification is performed to the LED fluorescent lamp 11 shown in FIG. 2. Optimum characteristics can be obtained in the LED fluorescent lamp 11 when the dome (area ratio) OS of the translucent cover 4 is 20% or more and the transmittance thereof is 40 to 60% likewise.

Next, lighting apparatuses of other embodiments will be described. In the other embodiments described below, the same sections as those of the above-described first embodiment are denoted by the same reference numerals and the detailed description thereof are omitted.

### Second Embodiment

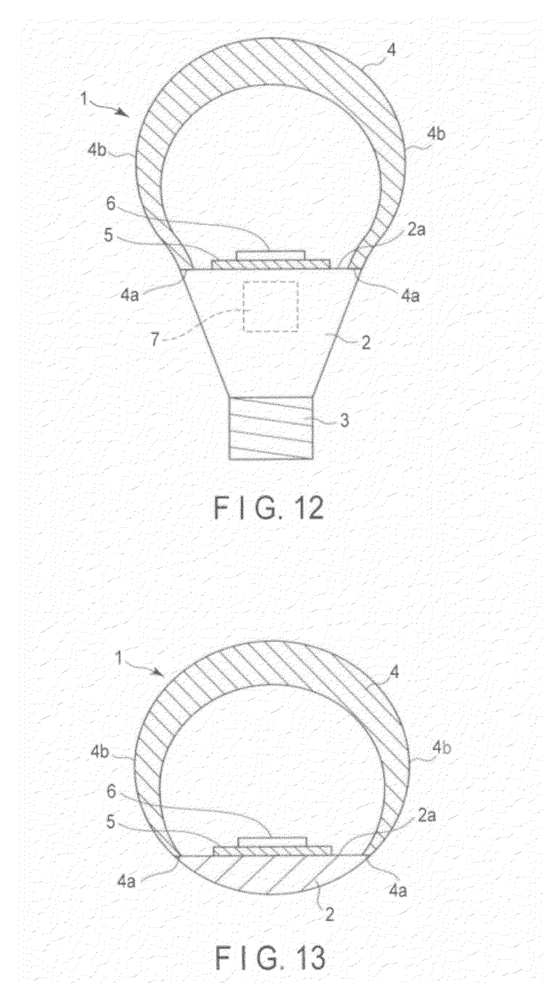

FIG. 12 shows an LED bulb 1 as an electric-bulb-type lighting apparatus according to a second embodiment, and FIG. 13 shows a cross-section of an LED fluorescent lamp 11 as a fluorescent-lamp-type lighting apparatus according to the second embodiment. The LED bulb 1 has a rotation-symmetrical shape to a center axis, and the LED fluorescent lamp 11 has a rod-shaped three dimensional shape obtained by extending an illustrated cross-section linearly or an annular shape obtained by extending an illustrated cross-section in a circle shape.

As shown in FIGS. 12 and 13, according to the second embodiment, a translucent cover 4 has a domed shape at a position higher than a light source 6, and the thickness of the translucent cover 4 is thick on a front side section and is thin on a rear surface side section. Although the material of the translucent cover 4 is the same as the above-described first embodiment, the thickness of the translucent cover 4 is gradually thinned so as to be made to, for example, 4 mm in the thickest section of a front surface side, and made to 0.8 mm in a rear surface side end. As described above, when the thickness of the translucent cover 4 is made thick in a front surface region and is made gradually thin on the side surface side or on the rear surface side, although unevenness is generated in which the luminance of the translucent cover 4 is reduced on the front surface side and is increased on the rear surface side, the luminous intensity on the rear surface side can be increased more than the oriented light distribution capable of being achieved by the shape of the translucent cover 4.

Note that even when the transmittance of the translucent cover 4 is partly different as in the second embodiment, the transmittance of the translucent cover 4 opposing to the light source is preferably 60% or less by the light orientation angle expansion effect described in the first embodiment.

### Third Embodiment

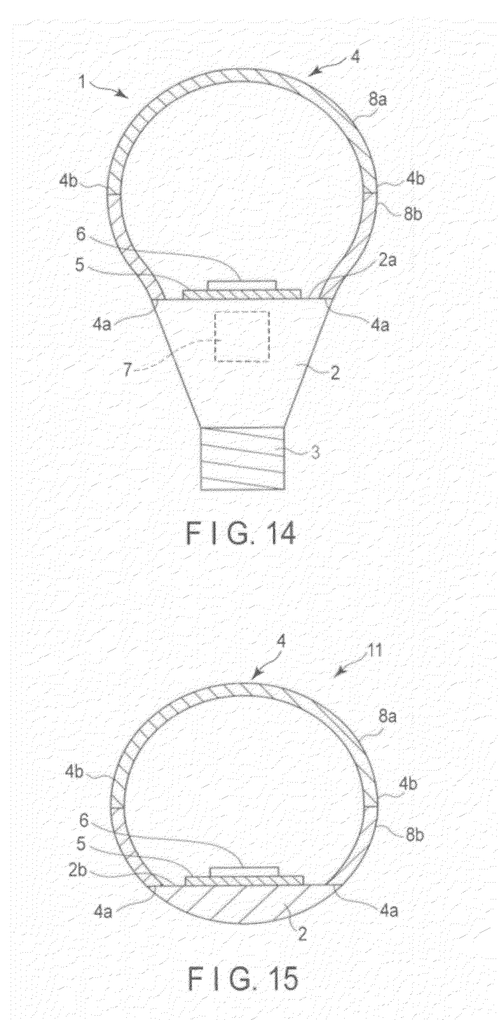

FIG. 14 shows an LED bulb 1 as an electric-bulb-type lighting apparatus according to a third embodiment, and FIG. 15 shows a cross-section of an LED fluorescent lamp 11 as a fluorescent-lamp-type lighting apparatus according to a fourth embodiment. The LED bulb 1 has a rotation-symmetrical shape to a center axis, and the LED fluorescent lamp 11 has a rod-shaped three dimensional shape extending linearly or an annular shape.

According to the third embodiment, a translucent cover 4 is formed in a domed shape having a maximum diameter section 4b or a maximum width section 4b whose diameter or width is larger than an opening end 4a. Further, the translucent cover 4 is divided to two upper and lower sections (front surface side and rear surface side) with the maximum diameter section 4b or the maximum width section 4b as a boundary and is composed of two sections of a front surface side section 8a and a rear surface side section 8b. Although the front surface side section 8a and the rear surface side section 8b are coupled with each other by the maximum diameter section 4b or the maximum width section 4b, the front surface side section 8a and the rear surface side section 8b are composed of a material having the same thickness and a different transmittance. The transmittance of the rear surface side section 8b is set higher than the transmittance of the front surface side section 8a. For example, the front surface side section 8a of the translucent cover 4 is formed to have the transmittance of 53% and the rear surface side section 8b of the translucent cover 4 is formed to have the transmittance of 86%.

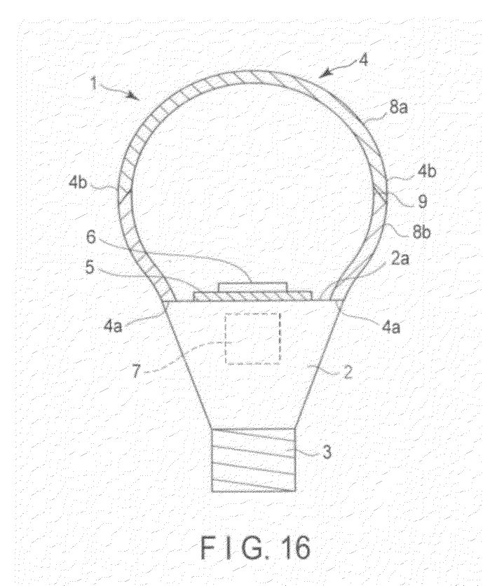

In such a configuration, the same effect as the above-described second embodiment can be obtained. In the above configuration, luminance unevenness of the translucent cover 4 occurs in the boundary of the two sections 8a, 8b that configure the translucent cover 4. To reduce such luminance unevenness, as shown in FIG. 16, the front surface side section 8a, the rear surface side section 8b and the boundary 9 may be obliquely formed to a center axis of the LED bulb 1, and the two sections 8a, 8b may be combined in a wedge shape. In this case, in the boundary 9, the front surface side section 8a and the rear surface side section 8b are positioned by being overlapped in the diameter direction of the translucent cover 4. With the configuration, a luminance difference viewed in the boundary section can be reduced and the luminance unevenness can be reduced.

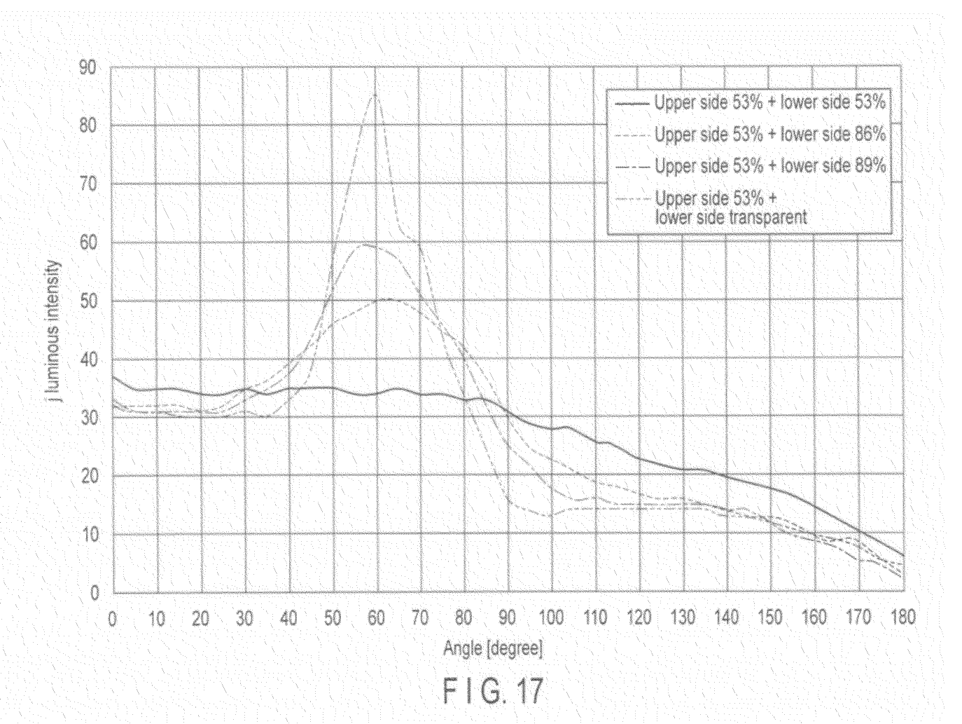

FIG. 17 shows the oriented light distributions of the electric bulb 1, respectively when the transmittance of the rear surface side section 8b of the translucent cover 4 is variously changed in the LED bulb 1 shown in FIG. 14, wherein the vertical axis represents luminous intensity and the horizontal axis represents azimuth angle wherein the normal direction of the front flat section 2a is set to 0°. From the drawing, as the oriented light distribution, although the translucent cover 4 having the uniform transmittance shown in FIG. 1 (upper side 53%, lower side 53%) is best, it is found that, in a specific application for outputting a strong luminous intensity to a side surface direction, the configurations shown in the second and third embodiments (an upper side 53%, a lower side 86%) and (an upper side 53%, a lower side 89%) are also useful. Even if the transmittance is changed in the upper and lower sections of the translucent cover 4, the oriented light distribution of the LED bulb 1 can be changed, so that an oriented light distribution according to an application can be provided.

### Fourth Embodiment

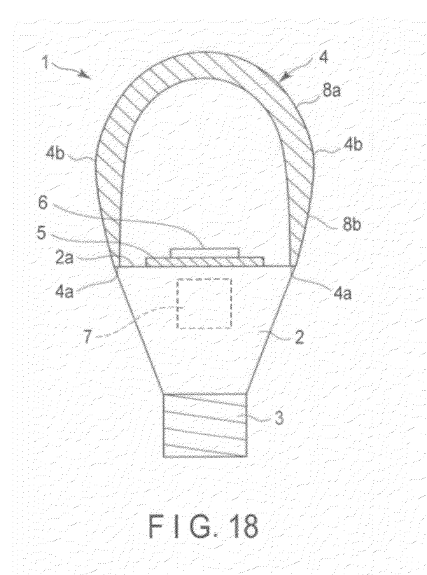

FIG. 18 shows an LED bulb 1 as an electric-bulb-type lighting apparatus according to a fourth embodiment. The LED bulb 1 has a rotational-symmetrical shape to a center axis. In the LED bulb 1 according to the fourth embodiment, an upper half section (a front surface side section) 8a of a translucent cover 4 is configured as a hemisphere shape having a thickness of 2.4 mm, and a lower half section (a rear surface side section) 8b having a height of about 20 mm is disposed from a lower end circular section of the hemisphere to a rear surface side. Although the upper end section of the lower section 8b of the translucent cover 4 has a thickness of 2.4 mm, the thickness of the lower section 8b is gradually reduced downward and formed in a thickness of 0.8 mm in an opening end 4a at a lower end.

The inner surface of the translucent cover 4 is formed in a taper shape in which the diameter of the inner surface is increased toward the opening end 4a, and the opening end 4a of the cover has a maximum inner diameter. The other configurations of the LED bulb 1 are the same as the above described various embodiments.

According to such configurations, the translucent cover 4 can be formed of one part by an injection molding process, and a manufacturing cost can be reduced.

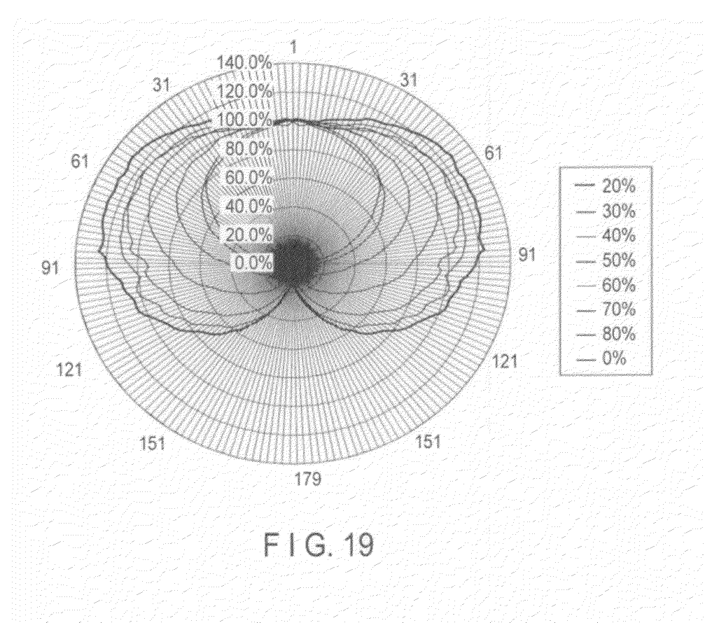

FIG. 19 shows the luminous intensity distribution in a radar chart when the transmittance of a dull resin that configures the translucent cover 4 is changed. FIG. 19 shows light intensities directed to respective azimuth directions assuming that the front surface of the LED bulb 1 faces an upper direction. The transmittance shows the transmittance when the thickness of the front surface region of the translucent cover 4 is 2.4 mm.

It can be found from the drawing that when the front surface transmittance is made to a low transmittance of 60% or less, the luminous intensity to the rear surface side can be rapidly made strong. In this embodiment, since the shape of the translucent cover 4 is distorted from a sphere, although the light intensities are distributed strong in a side surface direction, the translucent cover 4 can be formed of one part by injection molding and wide oriented lights and a low cost can be achieved at the same time.

### Fifth Embodiment

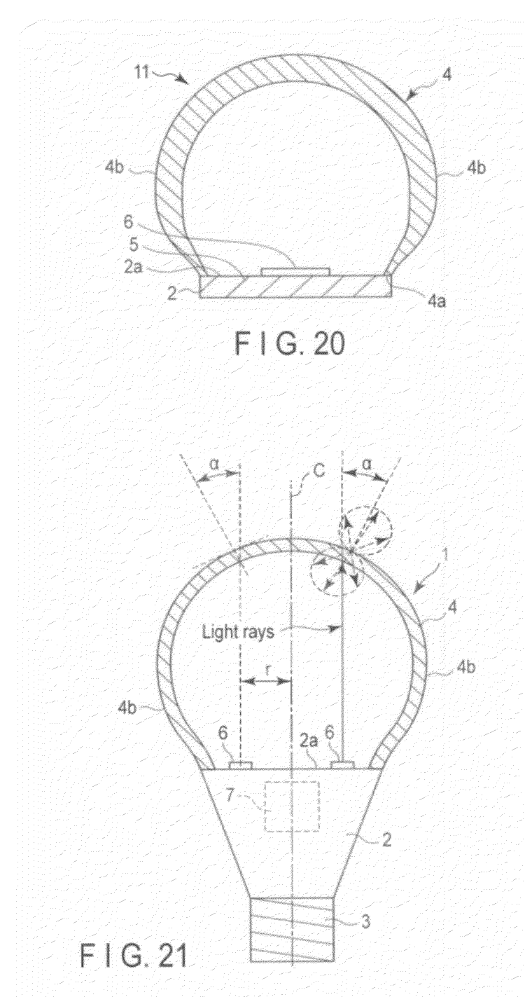

FIG. 20 shows an LED fluorescent lamp 11 according to a fifth embodiment. In the above-described lighting apparatuses according to the various embodiments, the LED substrate 5 may be used also as the base member 2, thereby the number of parts may be reduced as in a lighting apparatus according to an eighth embodiment. When the thickest section of a translucent cover 4 becomes 3 mm or more, since the strength of the lighting apparatus can be secured by the translucent cover 4, the translucent cover can be used as a base member in terms of strength, thereby the number of parts can be reduced.

In the above-described first embodiment, although the configuration of the LED bulb 1 or the LED fluorescent lamp 11 is specifically shown, the effect of the oriented light distribution is exerted by the translucent cover 4 which has the domed shape as well as is set to the transmittance of an appropriate range, the other configurations may be appropriately modified.

### Sixth Embodiment

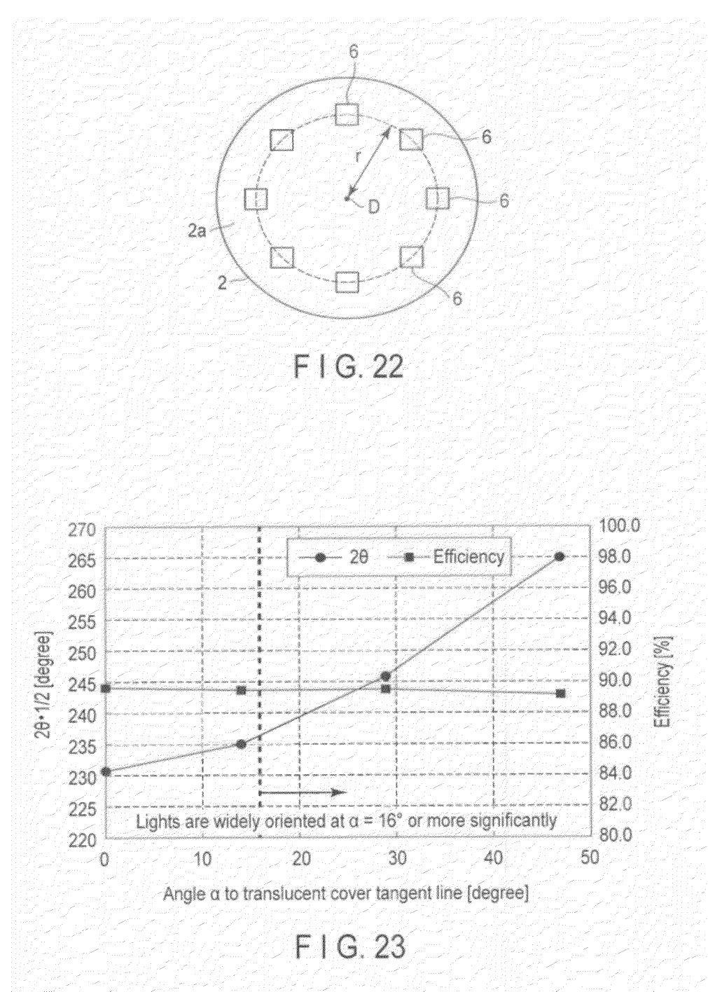

FIGS. 21 and 22 show an LED bulb 1 as an electric-bulb-type lighting apparatus according to a sixth embodiment. The LED bulb 1 has a rotation-symmetrical shape to a center axis. The basic configuration of the LED bulb 1 according to the sixth embodiment is the same as the first embodiment except that a light source 6 is disposed in a peripheral region offset by r=14 mm from a center axis C.

As shown in FIGS. 21 and 22, the LED bulb 1 includes, for example, a plurality of light sources 6 each composed of an LED, and these light sources are disposed on a circle having a radius of r=14 mm about a center axis C on the front flat section 2a of a base member 2 at equal intervals.

The translucent cover 4 is formed in a domed shape having a maximum diameter section 4a of 60 mm and has a thickness of 1.5 mm and a transmittance of 50%. The interval in a height direction between the maximum diameter section 4b of a translucent cover 4 and the front flat section 2a on which the light source 6 is mounted (in a direction vertical to the front flat section 2a) is 20 mm, the front flat section 2a has a maximum diameter of 48 mm and supports the translucent cover 4 by its periphery.

With the configuration, the half-value light orientation angle can be expanded 17° while keeping the equivalent efficiency to the configuration in which the light source 6 is disposed at the center of the base member 2 as in the first embodiment. The arrows of light rays of FIG. 21 schematically describe the expanding action of a half-value light orientation angle by disposing the light source 6 to a periphery. Although the light source 6 emits light most strongly in the normal direction of the front flat section 2a as a mounting surface, the strongest light in the normal direction is incident on the tilt surface of the translucent cover 4 at an angle a (in the embodiment, 29°) because the light source 6 is offset. Since the transmittance of the translucent cover 4 is set to 60% or less to sufficiently reflect and scatter the incident light, the main direction of the secondary light rays, which are reflected and scattered from the translucent cover 4 internally and externally (broken arrows), tilts by α, with a result that the translucent cover 4 exerts an action for expanding oriented lights.

FIG. 23 shows the variation of a half-value light orientation angle 2θ·½, and an efficiency when, in the LED bulb 1 shown in FIG. 21, the offset amount r of the light source 6 is changed to 0 to 21 mm and the angle α between a confronting translucent cover 4 and incident light is varied from 0 to 47°. From the drawing, it can be found that oriented lights are rapidly expanded from the vicinity of an angle at which the angle α exceeds 16° as well as the efficiency is not almost influenced.

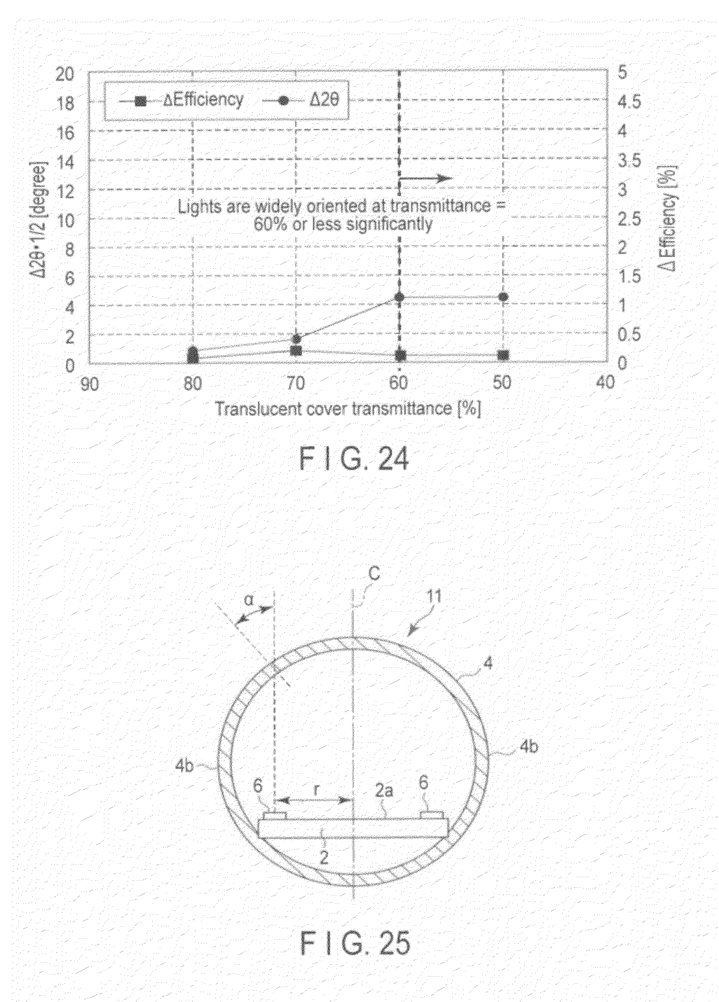

FIG. 24 shows the relationship between an oriented light expansion action and the transmittance of the translucent cover 4 when the light source 6 is disposed at a position offset from the center axis C 7 mm (14° in terms of the angle α). Δ2θ·½ and a Δ efficiency of a vertical axis is obtained by subtracting 2θ·½ and an efficiency from 2θ·½ and efficiency in a state that the light source 6 is disposed at a center from 2θ·½ and an efficiency when the light source 6 is offset by r=7 mm.

From the drawing, it can be found that the 20.1/2 increase effect by the offset of the light source becomes significant when the transmittance of the translucent cover 4 is 60% or less. This is because when the transmittance is high, the ratio at which the light emitted from the light source 6 directly passes through the translucent cover 4 as it is. Accordingly, it is desirable that the light source 6 is disposed as near to the translucent cover 4 as possible so that the light emitted from the light source 6 is obliquely incident on the translucent cover 4 as well as the translucent cover 4 is set to the transmittance of 60% or less to thereby sufficiently reflect and diffuse the light from the light source 6.

In the sixth embodiment, since only the disposition of the light source 6 and the transmittance of the translucent cover 4 are changed in design, the oriented light distribution can be expanded by a simple configuration without increasing a manufacturing cost. In the sixth embodiment, the transmission cover 4 is configured in the spherical shape with the uniform transmittance in consideration of attractiveness in appearance. However, since the electric bulb 1 causes the light with the strong directionality emitted from the light source 6 to be incident on the tilt surface of the opposing translucent cover and deflects the light in a side surface direction, a detailed light source mounting structure, a translucent cover shape, a material, and a base member are not limited to the above mode and can be appropriately changed.

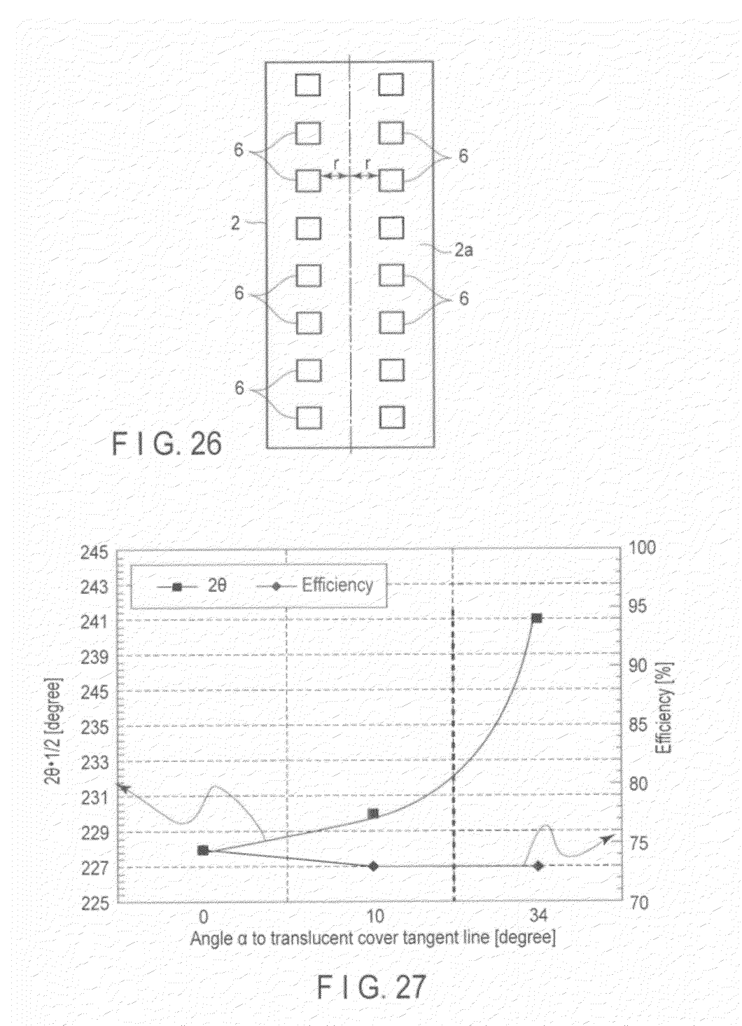

FIGS. 25 and 26 show the LED fluorescent lamp 11 according to the sixth embodiment as the fluorescent-lamp-type lighting apparatus. The basic configuration of the LED fluorescent lamp 11 is the same as the LED fluorescent lamp of the first embodiment except that the light sources 6 are disposed in two rows and disposed at positions near to the translucent cover 4. That is, a sheet-like base member 2 is installed 7.75 mm outside from the center of the translucent cover 4. The light sources 6 are disposed in a peripheral region offset from the center axis C in the two rows at positions away from the center axis C r=6.5 mm to a front flat section 2a having a width of 16 mm. The translucent cover 4 is formed of a spherical dull resin having a diameter of 25 mm and a thickness of 1.0 mm and the transmittance of the translucent cover 4 is set to a low value of 50%.

According to such configuration, the half-value light orientation angle can be expanded to 241° and thus can be relatively expanded 14° as compared with the light sources disposed in one row as in the first embodiment. FIG. 27 shows a verification of the variation of an angle range: 2θ·½ in which the luminous intensity is reduced to half and the efficiency when the offset amount r of the light sources 6 is changed and the angle α between an opposing translucent cover 4 and incident light is varied from 0 to 34° in the LED fluorescent lamp 11 shown in FIG. 25.

From the drawing, it can be found that 2θ·½ rapidly increases from the vicinity of an angle at which α exceeds 16° (2θ·½ is improved 5° or more as compared with the case that the light sources 6 are disposed at the center) as well as the efficiency is not almost influenced.

According to the respective embodiments described above in detail, a lighting apparatus, which can radiate light also in the side surface or rear surface direction as well as can be manufactured at a low cost, can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An lighting apparatus comprising:
a base member;
a light source configured to emit visible light; and
a translucent cover comprising a translucent region which covers at least a front surface of the light source and emits the light emitted from the light source to the outside, wherein
the light source is provided on a front surface flat section of the base member, a luminous intensity of the light emitted from the light source has a directionality which is strong in a normal direction of the front surface flat section and becomes zero on a rear surface side, and
the translucent cover comprises a domed shape having a maximum diameter at a position higher than a height of the position where the light source is arranged, and a transmittance of a region opposing the light source is 60% or less.

2. The lighting apparatus according to claim 1, wherein an average transmittance of the translucent cover is 40% or more.

3. The lighting apparatus according to claim 2, wherein when an angle between the normal direction of the light source and a surface normal direction of the translucent cover with which the normal line of the light source intersects is shown by a, the light source is arranged offsetting from a center axis so that angle a becomes 16° or more.

4. The lighting apparatus according to claim 1, wherein the area of the translucent region viewed from a rear surface side is 20% or more to the area of the lighting apparatus viewed from the rear surface side.

5. The lighting apparatus according to claim 1, wherein when an angle between a normal direction of the light source and a surface normal direction of the translucent cover with which the normal line of the light source intersects is shown by a, the light source is arranged offsetting from a center axis so that angle a becomes 16° or more.

6. The lighting apparatus according to claim 1, wherein, in the translucent cover, the transmittance of a rear surface side end of the translucent region is higher than the transmittance of the section of the translucent region opposing the light source.

7. The lighting apparatus according to claim 6, wherein the translucent cover is formed of a material having approximately constant transmittance, and a thickness of the translucent cover in the rear surface side end of the translucent region is thinner than a thickness of the translucent cover in the section of the translucent region opposing the light source.

8. The lighting apparatus according to claim 6, wherein the translucent cover is formed of a plurality of materials having a different transmittance and the transmittance of the material of the rear surface side end of the translucent region is higher than the transmittance of the material of the section of the translucent region opposing the light source.

9. The lighting apparatus according to claim 1, wherein the translucent cover is of an electric bulb type which comprises a maximum diameter section and a rear surface side region extending from the maximum diameter section to a rear surface side and wherein an inside diameter of the rear surface side region is maximized at an opening end of the translucent cover.

10. The lighting apparatus according to claim 1, wherein the lighting apparatus is an electric-bulb-type lighting apparatus configured to imitate an incandescent lamp and comprising an LED light source.

11. The lighting apparatus according to claim 1, wherein the lighting apparatus is a fluorescent-lamp-type lighting apparatus configured to imitate a fluorescent lamp and comprising an LED light source.
